(19) United States
(12) Patent Application Publication
(10) Pub. No.: US 2019/0253993 A1
(43) Pub. Date: Aug. 15, 2019

(54) System And Methods Relating To Two Layer Area Registration

(71) Applicant: Telefonaktiebolaget LM Ericsson (publ), Stockholm (SE)

(72) Inventors: Peter Ramle, Mölnlycke (SE); Josefin Karlsson, Torslanda (SE); Lasse Olsson, Träslövsläge (SE)

(21) Appl. No.: 16/345,396

(22) PCT Filed: Nov. 2, 2017
(86) PCT No.: PCT/SE2017/051090

§ 371 Date: Apr. 26, 2019

Related U.S. Application Data
(60) Provisional application No. 62/416,502, filed on Nov. 2, 2016.

(51) Int. Cl. H04W 60/00; H04W 68/04; H04W 4/02; H04W 88/02

(52) U.S. Cl. CPC H04W 60/00; H04W 88/023; H04W 4/027; H04W 68/04

(57) ABSTRACT

A two-layer structure and mechanism enabling a simple and efficient way to perform e.g. paging and reduce the network signalling is shown. A registration procedure is provided as is a core network, CN, initiated paging procedure operating on the basis of the two-layer structure.

### TECHNICAL FIELD

This invention is directed to methods and apparatus for registering user entities before network entities in a mobile communication network. More particularly, aspects of the invention relate to registration procedures and concepts for Next Gen, next generation, mobile communication standard based systems.

### BACKGROUND

In 3GPP SA2 (System Architecture—Stage 2 of the 3GPP network) there is a WI study, FS_NextGen (NG), which study the next generation 5G mobile network. The 3GPP progress so far is very premature. The architecture is still to be defined.

In 3GPP TR 23.799 v1.1.0 (2016-10) clause 4.1 “High level Architecture Requirements” it is stated:
“The architecture of the “Next Gen” network shall
1 Support the new RAT(s) (Radio Access Technologies), the Evolved E-UTRA (evolved UMTS Terrestrial Radio Access), and non-3GPP access types. GERAN (GSM EDGE Radio Access Network) and UTRAN (Universal Terrestrial Radio Access Network) are not supported:
a) As part of non-3GPP access types, WLAN (Wireless Local Access) access (including “untrusted WLAN” according to the meaning defined in pre Rel. 14 for the term “untrusted”) and Fixed access shall be supported. Support for satellite access is FFS (for further study).”

There exists an “Initial high-level view” of the architecture included into TR 23.799 v1.1.0 (2016-10) clause 4.2.1 (FIG. 1):

A reference architecture option is stated in TR 23.799 v1.10 (2016-10) clause 7.3.2:

The list of individual NG Core Control network functions (e.g. SMF (Session management part of NAS signalling exchanged with the UE) versus MMF (Mobility Management Function, Mobility management part of NAS signalling exchanged with the UE), or access specific versus access independent, etc.) is FFS. The interconnection model for all control plane network functions is FFS.

Need for NG8 from H-CCFs to NG-SDM (i.e. in the home routed scenario) is FFS.

NOTE 3: Regardless of the number of CCFs, there is only one NAS interface instance between the UE and the CN, terminated at one of the CCFs that implements at least access authentication and mobility management.

NOTE 4: Criteria to select multi-vendor open (standardized) interfaces should be determined. 7.3.3 Network functions and reference points

The 5G Reference Architecture consist of the following functions:
NG Subscriber Data Management (NG SDM (Subscriber Data Management))
NG Policy Control function (NG PCF (Policy Control Function))
NG Core Control functions (NG CCFs (Core Control Plane Functions))
NG Core User plane function (NG UPF (User Plane Function))
NG RAN (Radio Access Node)
NG UE (User Equipment)
Data network, e.g. operator services, Internet access or 3rd party services.

The following is a high-level split of functionality between the control plane and the user plane. The NG Core Control functions include the following functionality:
Termination of RAN CP interface
Termination of NAS (Network Access Stratum)
Access Authentication
NAS Ciphering and Integrity protection
Mobility management
Session Management
UE IP (Internet Protocol) address allocation & management (incl. optional Authorization)
Selection of UP function
Termination of interfaces towards Policy control and Charging functions
Policy & Charging rules handling, incl. control part of enforcement and QoS (Quality of Service)
Lawful intercept (CP and interface to LI (Lawful Intercept) System)

NOTE 5: Not all of the CCF functions are required to be supported in an instance of CCFs of a network slice

The NG Core User plane function includes the following functionality:
Anchor point for Intra-/Inter-RAT mobility (when applicable)
External PDU session point of interconnect (e.g. IP).
Packet routing & forwarding
QoS handling for User plane
Packet inspection and Policy rule enforcement
Lawful intercept (UP collection)
Traffic accounting and reporting

NOTE 6: Not all of the UPF functions are required to be supported in an instance of user plane function of a network slice.

The NG Policy function includes the following functionality:
Supports unified policy framework to govern network behaviour.
Provides policy rules to control plane function(s) to enforce them.

The need for an interface between NG Policy Function and SDM is FFS.

The 5G Reference Architecture contain the following reference points:

NG1: Reference point between the UE and the NG Core Control plane function.
NG2: Reference point between the RAN and the NG Core Control plane function.
NG3: Reference point between the RAN and the NG Core User plane function.
NG4: Reference point between the CP functions and the NG Core User plane function.
NG5: Reference point between the CP functions and an Application Function.
NG6: Reference point between the UP functions and a Data Network (DN).
NG6*: Reference point between a UP function and a local Data Network (when concurrent access to both a local and central data network is provided for one PDU session with a single IP address/prefix).

NOTE 7: Details of NG6* mechanism are beyond the scope of 3GPP.

NG7: Reference point between the NG Core Control plane function and the NG Policy Control function
NG8: Reference point between the NG Core Control plane function and the Subscriber Data Management.
NG9: Reference point between two NG Core User plane functions.
NG7r: Reference point between the V-PCF (Visiting-PCF) and the H-PCF (Home-PCF).
NG-RC: Reference point between the V-CCFs and the H-CCFs.

Editor's note: Whether additional reference points between UPFs need to be defined for other user-plane scenarios is FFS.

Prior at document US-2008/0220782 notes that the tracking area (TA) concept in LTE simplify mobile area tracking operations and reduce the overhead caused by the area updates for UEs (User equipment's (UEs)/transmit/receive units (WTRU)) and notes further that in the LTE_IDLE state, the network is aware of the UE only at a TA level. It is noted that, for paging and other purposes, the network can only contact the UE over all assigned TAs, which may unnecessarily increase the paging load and unnecessary tracking area update (TAU) requests. It is suggested that UE mobility detection from UE positioning measurement results, UE cell reselection numbers and the TAU counts, and by the use of adjustable TA timers should be provided. To achieve the proper balance of the TA allocation principles various TA allocation schemes are proposed:

1. Multiple TA list scheme. When the UE is in the stationary state or in the low mobility state, only one TA is assigned to the UE. With only one TA, the UE will not incur many TAUs, but the system can page the UE in a small scope area in one TA. When the UE is in the high mobility state, multiple TAs can be assigned to the UE to minimize the number of TAUs. However, each cell belongs to only one TA.
2. TA overlapping scheme. An individual cell may belong to more than one TA. A two-level TA coverage scheme is employed such that when the UE is in a high mobility state, the UE is assigned to a TA that covers a large geographical area with many individual LTE cells. With the larger TA, the UE does not have to perform many TAUs. When a UE is in the low mobility or stationary state, it is assigned to a TA that has a smaller geographical area with a
fewer number of cells. The transition between a large TA and a small TA may happen in a cell covered by both TAs.

A number of mechanisms for UE mobility detection are proposed: 1. Number of TAUs. When the UE is transitioning from the low mobility state to the high mobility state, counting the number of TAUs can be used as the threshold to trigger the change. 2. Number of cell reselection decisions 3. UE positioning assisted mobility detection. 4. UE mobility detection based on UE Doppler measurement. It is suggested that when the UE performs a TAU, the UE can send a TA Request message 714, which includes the UE mobility information (such as the location change information, the cell reselection count, or the derived UE mobility state information) to the network 704 on the assignment to the TAs. The UE mobility information can also include the UE's mobility state, the number of cell reselections, UE position change measurement results, and the preferred TA-ID. The network 704 responds to the TA Request message

714 by sending a TAU Accept message 716, which assigns new TAs with corresponding TA ID(s), TMSI(s), and TA timers, based on the UE mobility information contained in the TA Request message.

US-2014/0364155-A1 discloses a paging area control apparatus. The paging area control apparatus includes an algorithm selecting unit and a paging area, PA, determining unit. The algorithm selecting unit selects an algorithm that corresponds to a mobility characteristic of a mobile station from a plurality of paging area determining algorithms. The PA determining unit determines a paging area of the mobile station using the selected algorithm.

An algorithm involves specifying a geographical region whose dependence on the moving direction of the mobile station is large; and selecting, as the PA, a base station(s) that is within the geographical region or a cell(s) that at least partially overlaps with the geographical region. The geographical region whose dependence on the moving direction is large corresponds to a noncircular and non-spherical geographical region which preferentially covers a moving direction of the mobile station as compared to other directions. For example, the geographical region whose dependence on the moving direction is large is an ellipsoidal (two dimensions) or ellipsoidal (three dimensions) region.

In one embodiment, the mobility management node may obtain the temporal changes in the geographical location of any mobile station by referring to a collection history of GPS location information of the mobile station. The PA control node may determine the PA area of the mobile station. The size of the ellipse as the geographical region may be changed in accordance with the moving speed of the mobile station (e.g., the magnitude of the moving speed vector V).

US 2015/0038180 A1 shows a method for adjusting the number of base stations of a paging group based on the mobility state of a mobile device. The mobile device may autonomously determine its mobility state based on a sequence of repeated historical events associated with mobility patterns of the mobile device. The mobile device may communicate the mobility state to a base station and receive a page from at least one of a subset of base stations of a paging group. The subset of base stations may be selected based on the mobility state of the mobile device. The number of base stations selected to be included in the subset of base stations may be reduces when the mobile device is in a stationary state or increased when the mobile device is in a mobile state. Dynamically adjusting the number of base stations assigned to the subset of base stations of the paging group (and related reporting/control messaging) may have the benefit of reducing overhead signalling requirements as well as conserving time frequency resources at each base station.

U.S. Pat. No. 8,185,159B2 relates to providing individual TAI lists for individual mobile terminals in a LTE system. A predicted travel pattern is estimated based on a recent travel pattern. The wireless terminal, upon reception of notification information from a base station, judges whether an area included in the notification information is included in a location registration area list stored in a storage unit, and in the case where the area is not so included, sends a location registration request to a call processing control unit of the network. The call processing control unit on the other hand, creates a new location registration area list from the area included in the notification information and the areas in the neighbourhood of the area included in the notification information and sends it to the wireless terminal.

In FIG. 2, various schematic cell plans are shown comprising an UMTS/GSM and a LTE registration area, at the top/bottom, respectively, as known in the art. The registration area, REG area, is an aggregation of cells (indicated by pattern) where paging of UE's may be undertaken. In UMTS/GSM, the registration area is denoted, Routing Area, RA, and in LTE the registration area is denoted a Traffic Area, TA or TA List. So-called attributes are information elements that may apply to network functionality or the UE. One example of an attribute is network time and date. The finest granularity for an attribute area in LTE is the TA and is constituting of a number of cells. The finest granularity for an attribute area in UMTS/GSM is the Routing Area, RA, and is constituting of a number of cells. In a network, both GSM, UMTS and LTE Radio Access may be provided in the same area such that cells of the various RA technologies are overlapping. The cell size and shape may of course differ for the RA's.

### SUMMARY

It is first object to set forth a two-layer structure and apparatuses and methods therefore enabling an efficient control and configuration of e.g. paging while reducing network signalling.

It is a further object of the invention to set forth an efficient way of creating both smaller and larger areas to be used for e.g. paging. A mixing of the granularity need for geographical attribute handling with the granularity need for reachability paging handling could create a compromise not optimized for both needs. This can be avoided according to some aspects of the invention.

According to a first aspect of the invention there is provided a method for a user entity, UE, in a radio access network comprising a plurality of cells in a cell plan for which a coordinate system is defined, wherein each cell is associated with a geographical location denoted cell coordinates in the coordinate system. The network providing radio access and communicating with the user entity, wherein an attribute area associated with at least one attribute of the network. The attribute area is defined for a first plurality of cells, and a registration area is serving for defining a second plurality of cells of a paging area, the registration area being defined independently from the attribute area. The registration area is defined by a geographical object descriptor comprising at least a set of geographical coordinates of the coordinate system. The method comprises—receiving a registration, REG, area represented by a geographical object descriptor; —receiving an attribute, ATT, area; and on an iterative basis
moving or remaining stationary;
sensing a possible new different cell from a previous cell and learning the cell coordinates of the new different cell;
sensing an ATT area change;
determining whether at least one of
   the cell coordinates are outside the registration area defined by the geographical object descriptor, and
   an attribute area change has occurred;
   if so, performing at least a registration area update with the network involving receiving a new geographical object descriptor associated with an updated registration area;
   otherwise, performing the steps noted under said iterative basis.

According to a second aspect of the invention there is provided a method for a network node entity such as a Mobility Management Function, MMF, node in a network comprising a plurality of cells in a cell plan for which a coordinate system is defined, wherein each cell is associated with a geographical location denoted cell coordinates in the coordinate system; the network providing radio access and communicating with the user entity.

An attribute area is associated with at least one attribute of the network, the attribute area being defined for a first plurality of cells. A registration area is serving for defining a second plurality of cells of a paging area and the registration area is defined independently from the attribute area. The registration area is defined by a geographical object descriptor comprising at least a set of geographical coordinates of the coordinate system. The method comprises
performing a registration area update for a UE;
receiving at least the cell coordinates of a newly sensed cell;
calculating an updated registration area for the UE defined by a new geographic object descriptor based on at least the cell coordinates of the newly sensed cell;
issuing the updated registration area to the UE.

According to a further aspect of the invention there is provided a user entity, UE, in a radio access network comprising a plurality of cells in a cell plan for which a coordinate system is defined, wherein each cell is associated with a geographical location denoted cell coordinates in the coordinate system; the network providing radio access and communicating with the user entity, wherein an attribute area associated with at least one attribute of the network, the attribute area being defined for a first plurality of cells, a registration area serving for defining a second plurality of cells of a paging area, the registration area being defined independently from the attribute area, the registration area being defined by a geographical object descriptor comprising at least a set of geographical coordinates of the coordinate system, the user entity being further adapted for
receiving a registration, REG, area represented by a geographical object descriptor;
receiving an attribute, ATT, area;
   on an iterative basis
moving or remaining stationary;
sensing a possible new different cell from a previous cell and learning the cell coordinates of the new different cell;
sensing an ATT area change;
determining whether at least one of
   the cell coordinates are outside the registration area defined by the geographical object descriptor, and
   an attribute area change has occurred;
   if so, performing at least a registration area update with the network involving receiving a new geographical object descriptor associated with an updated registration area;
   otherwise, performing the steps noted under said iterative basis.

According to a further aspect of the invention there is provided a network node entity such as Mobility Management Function, MMF, node in a network comprising a plurality of cells in a cell plan for which a coordinate system is defined, wherein each cell is associated with a geographical location denoted cell coordinates in the coordinate system; the network providing radio access and communicating with the user entity,

wherein an attribute area associated with at least one attribute of the network, the attribute area being defined for a first plurality of cells, a registration area serving for defining a second plurality of cells of a paging area, the registration area being defined independently from the attribute area, the registration area being defined by a geographical object descriptor comprising at least a set of geographical coordinates of the coordinate system, the network node entity being adapted for
performing a registration area update for a UE;
receiving at least the cell coordinates of a newly sensed cell;
calculating an updated registration area for the UE defined by a new geographic object descriptor based on at least the cell coordinates of the newly sensed cell;
issuing the updated registration area to the UE.

### BRIEF DESCRIPTION OF THE DRAWINGS

FIG. 1 shows a known NextGen reference architecture showing moreover a UE, RAN, Core node and data network,

FIG. 2 shows various registration areas of prior art networks,

FIG. 3 shows resource needs versus area size according to an aspect of the invention,

FIG. 4 shows an elliptic area according to an aspect of the invention,

FIG. 5 shows a first layer registration area formed as an ellipse and a second layer attribute area according to an aspect of the invention,

FIG. 6a, 6b show flow charts for a UE and network,

FIG. 7a, 7b show flow charts for a UE and network according to a further embodiment,

FIG. 8 shows an exemplary registration procedure,

FIG. 9 shows an exemplary core network initiated paging procedure,

FIG. 10 shows embodiments of a user equipment, UE, a radio access node, RAN, and a MMF according to the invention, and

FIG. 11, 12 show further implementation examples.

### DETAILED DESCRIPTION

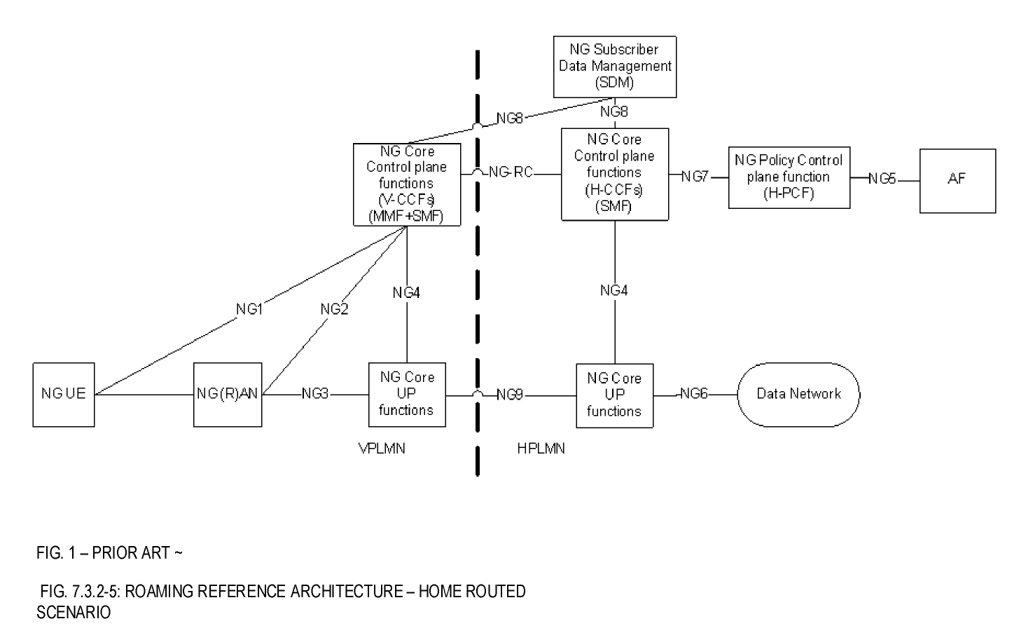

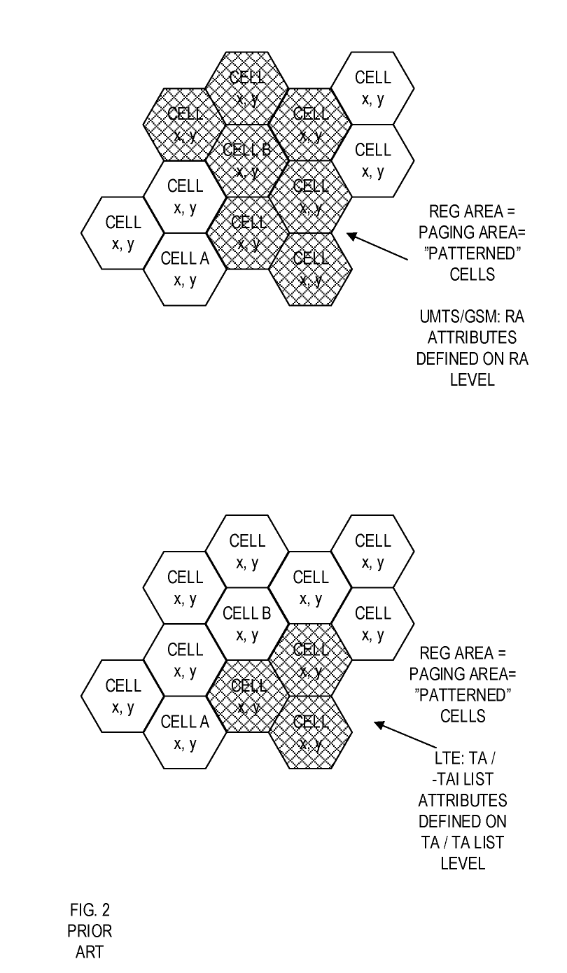

In this invention the architecture option given above according to FIG. 1 may be used.

NG Policy Control Plane function (NG PCF) is a similar function as PCRF used for GERAN, UTRAN and E-UTRAN.

NG Core Control Plane function (NG CCF) represents the control plane of the Core Network (CN) and has the similar functionality as the Mobility Management Entity (MME), and also the control plane of the Serving Gateway (S-GW) and the Packet Data Network (PDN) Gateway (PGW) in E-UTRAN.

It should be noted that GERAN and UTRAN is not supported in 5G.

In NextGen a diverse set of UE/applications are to be supported. This means that both UEs with static or semi-static mobility characteristics as well as UEs with medium or high-speed mobility, needs to be supported.

In order to save paging resources, the registration area for UEs of the former type should be rather small (e.g. one or small number of cells) compared with the legacy system, so that the network may trace a static or semi-static UE in only a few cells. However, if the registration area is small then the frequency of registration area update will become rather high for UEs with medium or high speed, increasing both power consumption and signalling. Therefore, the size of the registration area needs to be adapted on an individual UE level, based on the UEs mobility characteristics.

Use of a small size base entity (e.g. a small size TA (Tracking Area)) to describe the finest granularity will suit UEs with static or semi-static mobility characteristics as such a UE's registration area then is described by use of only a few cell identities.

However, UEs with medium or high speed requires registration areas of a comparably larger size meaning that a considerable amount of cell identities would need to be used to define their respective registration area. Conveying a registration area to a UE as a set of cell identities would also mean a lot of data over the air interface.

Using only cell identities would mean that all 3GPP defined geographical attributes like e.g. Time zone, Roaming restrictions and Equivalent PLMN (Public Land Mobile Network) lists need to be configured on a Cell Id level, a rather big O&M (Operation and Maintenance) task. And before assigning a registration area to a UE the network will need to check that all included cells have the same attribute setting. It is therefore not seen as a feasible solution to use the Cell ID (Identity) level as a base for both configuration of attributes and for composing registration areas.

As it is assumed that the geographical attributes are homogenous on a larger area than a few cells like e.g. an area the size of larger Tracking Area, TA, it would be suitable to use the TA or TAI-list concept for that level of area.

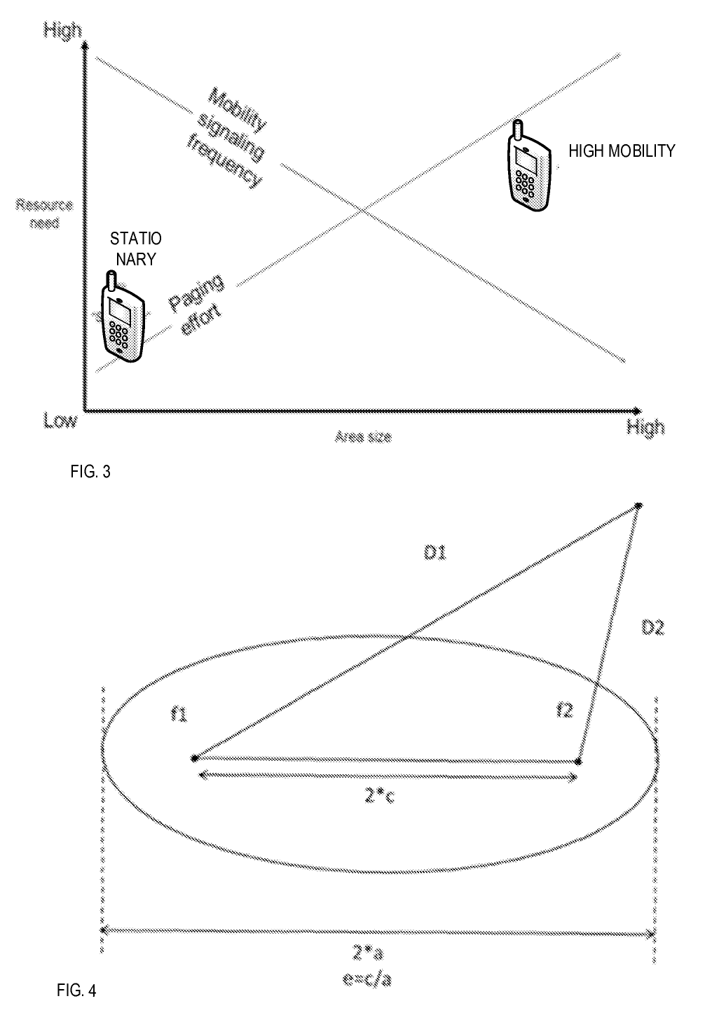

In FIG. 3, the area size effect on Paging and Mobility signalling frequency which affects the resources need in the network is schematically illustrated. As shown a large area size has the effect that a UE will be paged in a large number of cells. Since the area is large registration signalling will be rare and mobility signalling level will be low. If the cell is small on other hand, the paging activity or effort will be correspondingly small, but since UE's are more likely to leave and move into the area, the mobility signalling level will be high.

When deciding upon and conveying the registration area for a UE and instructing the UE on when to perform registration updates, it is not only about paging efficiency and reachability. It is also about assuring that a UE doesn't unnoticed cross a border with different geographical attributes. All this should be achieved with a minimum of O&M (Operation and Maintenance) effort, and a minimum of data and signalling to and from UE.

### Two-Area Layer Structure According to Aspects of the Invention:

First layer here denoted registration area, REG area, 401, including an area used by the UE to trigger a registration update (i.e. a normal mobility registration update). The network uses the same area at initiation of paging.

Second layer here denoted attribute area, ATT area, 402, including an area used by the UE to trigger a registration update to enable the network to apply a geographical attributes change for the UE.

The invention is applicable to a variety radio access technologies such as GSM (global system for mobile telephone networks); UMTS (Universal Mobile Telecommunications System), LTE (Long Term Evolution) and 5G-New Radio (NR)/Next generation (NR) as well as to combinations thereof.

Aspects of the invention enables the network to create the first layer as either a small or large area, a flexible area but also to dynamically create an area depending on the expected UE mobility pattern. The first layer is an efficient way to create an area keeping the parameters reflecting the area to a few parameters but also making it simple for the UE and the network to use. Enables the network to create a large area covering an area where UE unique geographical attributes are set to the same values.

Introducing of a two-layer structure for a UE, will reduce signalling in the network but also reduce latency as e.g. paging can be performed in a smaller area.

As UEs can have different characteristics where some are stationary or low mobility while others are medium or high mobility, the first layer could reflect this by setting the area to a small or large size with different shapes depending on the UE speed but also for UEs moving, the direction aspect could be taken into consideration.

When deciding upon and conveying the registration area for a UE and instructing the UE on when to perform Registration Updates, it is not only about paging efficiency and reachability. It is also about assuring that a UE does not unnoticed cross a border with different geographical attributes. All this should be achieved with a minimum of operation and maintenance, O&M, effort and a minimum of data and signalling to and from UE.

### A Two-Layer Structure it is Proposed Wherein:

The first layer addresses the issue of paging efficiency by using a dynamic assignment of the registration area individually per UE and without using a heap of data.

The second layer addresses the issue of configuration effort and of getting registration updates from a UE at geographical attribute change due to mobility.

The two-layer structure enables a separation of the areas used for reachability/paging and areas used for any UE attribute change thus making them independent.

In this context, Registration Updates are used for the UE to trigger a registration to the mobile network but also when the UE is required to trigger a Registration Update to the network due to mobility. Registration Update is similar to Attach Request and Tracking Area, TA, Update as used in 4G (LTE).

### First Layer—Registration, REG, Areas:

By defining an XY-coordinate system for a PLMN it is possible to assign each cell within a PLMN an XY-coordinate for the centre of the cell. This coordinate is representing the cell and shall be broadcasted in the cell and read by a UE whenever the UE intends to camp on a cell. When a UE tries to register in a cell the XY-coordinate is noted by the network and used in calculation of the registration area assigned to the UE.

Depending on UE mobility pattern, position/speed/velocity and other characteristics of the UE, a size and shape of the registration area is defined. The position/speed/velocity of the UE may optionally be provided by geo-position systems and for instance be based on GPS (Global Positioning System), GLONASS (Global Navigation Satellite System) etc. or by means using trigonometric estimations based on signalling from the radio network.

Instead of defining this area as a set of cell identities it is proposed to define a registration area as a two-dimensional geometrical figure that may depend dynamically on the position and behaviour of the UE. The simplest example would be a circle for a stationary subscriber and to handle the case of a UE moving in a certain direction an ellipse could be used. The radius of the circle could e.g. be adjusted based on the time the UE has been noted as stationary. The size and the eccentricity of the ellipse could be based on the noted speed of the UE. One of the focal points (or the only one in case of a circle) is already known by the UE as the XY-coordinate of its current cell (as broadcasted information). The other parameters (radius or second focal point+eccentricity) are sent by the network in the accept message.

A UE that has received a registration area should for each new cell where it attempts to camp check if the cell is within the registration area and if not initiate a registration update attempt. As each cell will broadcast its centre coordinates it is fairly easy to calculate if the new cell is within e.g. the assigned circle or ellipse, see example below.

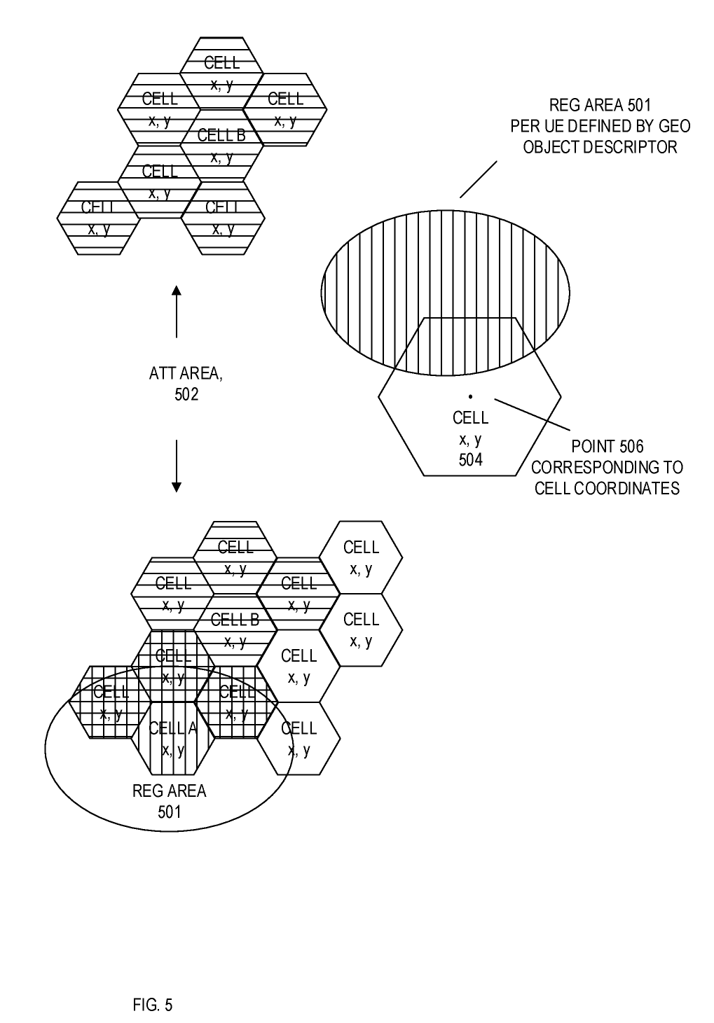

In FIG. 4, there is shown an eccentricity (e), a focal point 1 (f1), a focal point 2 (f2), a distance from a new cell to f1 (D1) and a distance from a new cell to f2 (D2). The following applies:
Circle:
Current cell=X1, Y1
New cell=X2, Y2
Assigned radius=R
New cell is within the circle if \sqrt{(X2−X1)²+(Y2−Y1)²}<R
Ellipse:
Current cell (focal point 1, f1)=X1, Y1
Focal point 2, f2=X2, Y2
Eccentricity=e (small values of e should be avoided)
New cell=X3, Y3
Linear eccentricity c=½\sqrt{(X2−X1)²+(Y2−Y1)²}
Distance new cell to f1: D1=\sqrt{(X3−X1)²+(Y3−Y1)²}
Distance new cell to f2: D2=\sqrt{(X3−X2)²+(Y3−Y2)²}
New cell is within the ellipse if D1+D2<2*c/e

### Second Layer—Attribute, ATT, Areas:

As the sole purpose of the second layer is to catch UEs crossing the border of a changed geographical attribute setting, the second layer geographical entity only needs to be adapted for that purpose. Thereby, the size of such an area could be considerably larger than a few cells. It is anticipated that the size would be equal to or larger than the size of a TA. For that reason, a Traffic Area, TA or TAI (Traffic Area Identifier)-list area would be possible to use.

The TAI should be broadcasted in each cell and read by a UE whenever the UE intends to camp on a cell. When a UE tries to register in a cell the TAI is noted by the network and assigned (possibly together with a TAI-list) to the UE. A UE that has received a registered TAI or TAI list should for each new cell where it attempts to camp check if the broadcasted new TAI is outside the TA or TAI-list area and if so make a registration update attempt. In this way it is assured that the correct geographical attributes are applied for a UE wherever the UE camps.

With large size TAs the signalling burden imposed due to attribute change would be minor and could even be further reduced by using the TAI-list area concept.

As an alternative (for 2G and 3G), the second layer could be a Routing Area (RA) or a Routing Area list (RA-list).

In FIG. 5, examples of an attribute, ATT, area comprising a first plurality of cells and a registration, REG, area comprising a second plurality of cells according to embodiments of the invention are shown.

The registration area for a UE is defined by a geographical object descriptor, for instance by an ellipse as mentioned above. The UE utilizes the geographical object descriptor to judge whether a given cell, to which the UE may have radio access, is within or outside the area defined by the geographical object descriptor. For this judgment, the cell coordinates, which may be the centre cell coordinates or more precisely the base station antenna coordinates for example longitude, and latitude X, Y of a geographic coordinate system. Consequently, the UE may determine its position with respect to being inside or outside the registration area by determining whether the cell coordinates 506 of a cell 504 are inside or outside the area defined by the geographical object descriptor defining the REG area 501. In the bottom cell plan illustration of FIG. 5, the cells which are considered within the REG area are indicated with vertical lines pattern. Both paging and registration update is undertaken in the cells according to the REG area defined by the geographical object descriptor. According to embodiments of the invention, when one and the same REG area, defined by one geographical object descriptor are known to the UE and the network, paging and registration update activities are aligned and synchronised with one another. The mechanisms for paging and registration update may be implemented as known in the art.

According to embodiments of the invention, an attribute, ATT, area 502 is constituted by an aggregation of cells, which in the upper and lower part of FIG. 5 is indicated by the vertical patterned cells. It is noted that some cells are found both in the REG area and ATT area. It is also noted that the REG area and the ATT area can be defined independently of one another. Moreover, the REG area is dynamically defined in time for a UE, whereas the ATT area is independent of the location of the UE but tied to the network and cell plans.

It shall be noted that using a circle or an ellipse is only two examples of possible geometrical figures to use. Other geometrical figures may also be used or combinations thereof. E.g. a chain of ellipses (inter chained by using one of the focal points as common between two ellipses) could be used to describe a UE that is moving fast. Another example could be combining a circle with an ellipse to handle a UE with a lower speed but still a higher grade of probability of moving in the direction of the assigned ellipse.

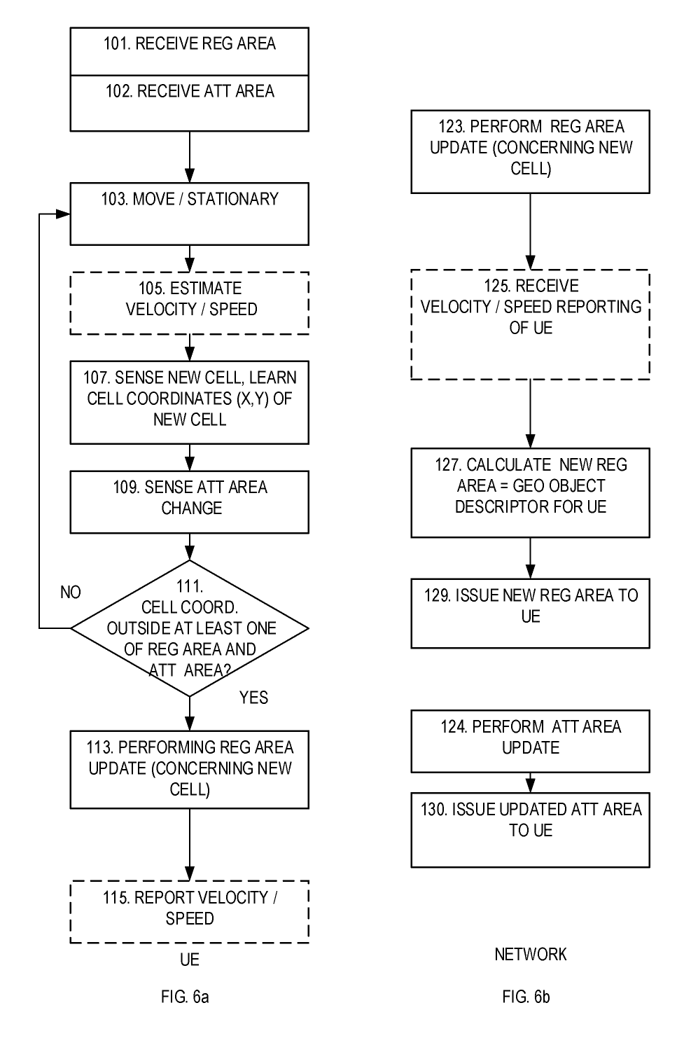

In FIG. 6a, a flowchart according to an embodiment is indicated for a UE. In step 101, the UE receives a geographical object descriptor describing a given REG area of the first layer. This registration area may have any arbitrary shape; however, it may advantageously be formed as circle or it may be formed as an ellipsoid as explained above. The UE also receives or has information concerning an ATT area, 102.

The UE may move or remain stationary, step 103. As the UE is moving the UE may optionally sense its velocity, 105. It is understood that while moving within the registration area and possibly crossing individual cells, no registration update is initiated by the UE. It also noted that as long as the UE is within the registration area, according to one embodiment, the UE will be paged in the cells inside the registration area. While moving or remaining stationary the UE receives information concerning the cell centre coordinates of which cell it is currently attached. Whenever a new cell is encountered, the UE learns the cell coordinates (X, Y), step 107. The UE may moreover sense whether a 2'nd layer ATT change is applicable in association with a newly encountered cell, 109.

The UE performs a determination as to whether the newly received cell coordinates are outside the REG area defined by the pending geographical descriptor, 111.

If any of sensing an ATT change or any cell coordinates of a new cell is outside the registration area are found, 111, the UE initiates or performs a registration update procedure with the network, 113 (confer step 123 below). If the condition of step 111 is not fulfilled, the UE continues with step 103, without performing registration update with the network. In a further embodiment, in step 105, the velocity or speed may be estimated and in step 115, the velocity or speed may be reported to the network. The direction of change and the velocity of the UE can be estimated from the recent and the new cell coordinates.

The network related actions are schematically explained in FIG. 6b according to an embodiment. In step 123, the network engages in the registration update procedure with the UE. Thereby, the cell identity/cell coordinates of the new cell may be obtained, The network may (for instance based on cell coordinate change/cell ID's) sense and estimate the velocity of the UE or receive 125 additional reporting 115 from the UE concerning its current velocity or speed. The network, based on the recent location of the UE, and possibly on the velocity of the UE, determines 127 a new suitable registration area to be assigned to the UE which is suited to a prognosticated behaviour of the UE and calculates a new geographical descriptor for the new registration area. Subsequently, the network issues the geographical object descriptor to the UE for the new area, 129.

The network performs ATT update if needed, 124 and issues an updated ATT area to the 130. The ATT update may be triggered by a separate parallel procedure to the one shown in FIG. 6A for instance in accordance with existing procedures known in the art (not shown).

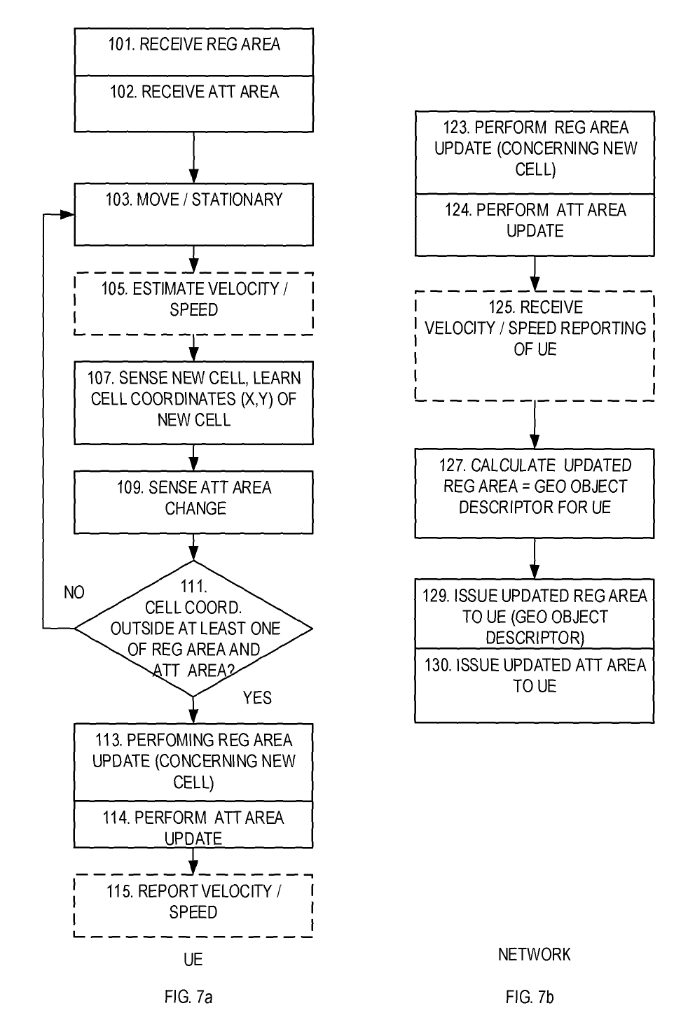

In FIGS. 7a and 7b an alternative embodiment has been shown. According to a further embodiment, whenever condition 111 is fulfilled also an ATT update is carried out.

It is envisioned that information elements related to REG and ATT updates would be small in relation to the signalling involved for the registration procedure. Hence, the extra overhead involved in performing an update of both REG area or ATT area, would be small in relation to performing an update of only one of a REG are and a ATT area.

In this embodiment both REG and ATT area updates are triggered, when one of the cell coordinates being outside the current REG area and an ATT area change has been sensed. Hence, also for the network side, the network performs an ATT area update, 124 in connection with any REG area update 123. It is understood that completing the procedures without any changing input would lead to an unchanged result for the REG and for the ATT areas. The network transmits an updated ATT area to the UE, 130 in connection with transmitting an updated REG area.

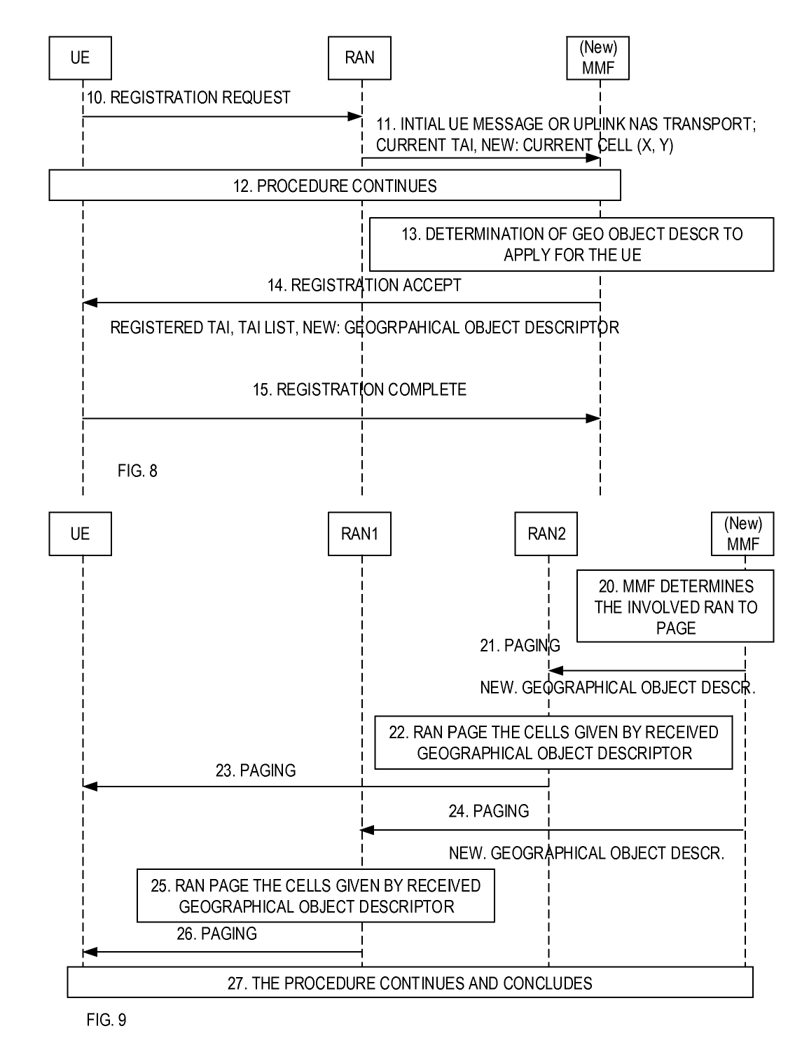

In FIG. 8 an example Registration procedure is shown. In this embodiment a radio access node, RAN provides radio access to a user entity, UE. A mobility management function, MMF, performs mobility management of the network.

The procedure shown includes registration steps without taking session aspects into consideration for simplicity reasons.
10) UE sends a Registration Request e.g. due to mobility (corresponding to performing REG update 113).
11) RAN forwards the Registration Request and includes also current TAI, current ECGI (E-UTRAN Cell Global Identifier) and NEW current cell (X, Y). (X, Y) are coordinates as described above.
12) The registration procedure continues
13) MMF calculates/determines (c.f. step 127 above) which geographical object descriptor to apply for the UE based on e.g. subscription information, policies in the network, mobility pattern, velocity etc. The resulting geographical object descriptor is a prediction of where the UE is expected to be located.
   The procedure continues
14) MMF sends Registration Accept (c.f. step 129) including NEW Geographical object descriptor.
15) UE may send Registration Complete.

NOTE: The geographical Object Descriptor is both an identification of the used geographical object as well as a description of its size and shape.

In FIG. 9, an example Core Network, CN, initiated paging procedure is shown:
20) MMF determines applicable RAN to page in the REG area (based on knowledge of each cell's (X, Y) coordinates and the relation between cells and RAN entities. This could be accomplished through configuration in MMF or provided by RAN at setup).
21) MMF sends Paging to all applicable RAN entities in the REG area
22) and 23) Each RAN entity performs page in the cells of the REG area given by the received geographical object descriptor
23
24) MMF sends Paging to an applicable RAN
25) as described in step 22) and 23)
26) as described in step 22) and 23)
27) The paging procedure continues and concludes

In a RAN triggered Paging, the MMF provides the RAN with Geographical object descriptor whenever the UE enters connected state. This means that the RAN entity at RAN paging has the necessary information to select cells to page in.

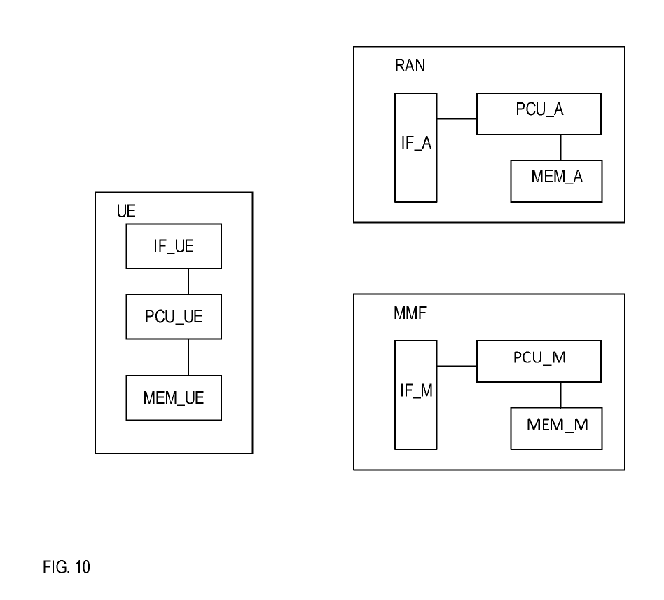

In FIG. 10, there is shown a user equipment, UE, apparatus according to the invention.

The apparatus comprises a processor PCU_UE an interface IF_UE and a memory, MEM_UE, in which memory instructions are stored for carrying out the process steps shown above. The processor carries out the instructions.

There is moreover shown a MMF comprising a processor PCU_M, an inter-face IF_M; and a memory, MEM_M. Instructions are stored in the memory for being performed by the processor and effectuated on the interface for carrying out the process steps shown above with relation to the figures above.

Finally, a radio access node, RAN1, RAN2 is shown comprising a processor PCU_A, an interface IF_A; and a memory, MEM_A. Instructions are stored in the memory for being performed by the processor and effectuated on the interface for carrying out the process steps shown above.

To summarize, according to embodiments of the invention there is provided:

A method for a user entity, UE, in a radio access network comprising a plurality of cells in a cell plan for which a coordinate system is defined, wherein each cell is associated with a geographical location X, Y denoted cell coordinates in the coordinate system. The network providing radio access and communicating with the user entity, wherein an attribute area 502 associated with at least one attribute of the network. The attribute area is defined for a first plurality of cells, and a registration area 501 is serving for defining a second plurality of cells of a paging area, the registration area being defined independently from the attribute area 502. The registration area is defined by a geographical object descriptor comprising at least a set of geographical coordinates f1, f2 of the coordinate system. The method comprises—receiving 101 a registration, REG, area represented by a geographical object descriptor; —receiving 102 an attribute, ATT, area; and on an iterative basis
moving 103 or remaining stationary;
sensing 107 a possible new different cell from a previous cell and learning the cell coordinates X, Y of the new different cell;
sensing 109 an ATT area change;
determining 111 whether at least one of
   the cell coordinates X, Y are outside the registration area defined by the geographical object descriptor, and
   an attribute area change has occurred;
   if so, performing 113 at least a registration area update with the network involving receiving a new geographical object descriptor associated with an updated registration area;
   otherwise, performing the steps 103, 107, 109 noted under said iterative basis.

The geographical object descriptor may comprise further a designated geometric function and at least one geometric parameter e, R for the designated geometric function. The cell coordinates X, Y may be cell centre coordinates.

The UE may moreover—perform 114 an attribute area update in connection with the registration area update 113.

The UE may moreover perform 105 further an estimation of the speed or the velocity of the UE, and—report 115 the speed or the velocity of the UE to the network.

Alternatively, the network is adapted to estimate the speed or the velocity of the UE from the cell coordinates of a previous and a new cell.

The attribute area may be associated with geographical attributes concerning at least one of time zone, roaming restrictions and equivalent Public Land Mobile Network, PLMN, lists.

There is also provided a method for a network node entity such as a Mobility Management Function, MMF, node in a network comprising a plurality of cells in a cell plan for which a coordinate system is defined, wherein each cell is associated with a geographical location X, Y denoted cell coordinates in the coordinate system; the network providing radio access and communicating with the user entity.

An attribute area 502 is associated with at least one attribute of the network, the attribute area being defined for a first plurality of cells. A registration area 501 is serving for defining a second plurality of cells of a paging area and the registration area is defined independently from the attribute area 502. The registration area is defined by a geographical object descriptor comprising at least a set of geographical coordinates f1, f2 of the coordinate system. The method comprises
performing 123 a registration area update for a UE;
receiving 125 at least the cell coordinates X, Y of a newly sensed cell;
calculating 127 an updated registration area for the UE defined by a new geographic object descriptor based on at least the cell coordinates of the newly sensed cell;
issuing 129 the updated registration area to the UE.

The geographical object descriptor comprises a set of geographical coordinates f1, f2, a designated geometric function and at least one geometric parameter e, R for the designated geometric function that defines a geographical location and area.

A program or computer program product is provided comprising instructions adapted for being stored in a memory MEM_A, MEM_M and adapted for, when executed by a processor PCU_A, PCU_M, carrying out steps defined above and in the figures.

A user entity, UE, in a radio access network comprising a plurality of cells in a cell plan for which a coordinate system is defined, wherein each cell is associated with a geographical location X, Y denoted cell coordinates in the coordinate system; the network providing radio access and communicating with the user entity, wherein an attribute area 502 associated with at least one attribute of the network, the attribute area being defined for a first plurality of cells, a registration area 501 serving for defining a second plurality of cells of a paging area, the registration area being defined independently from the attribute area 502, the registration area being defined by a geographical object descriptor comprising at least a set of geographical coordinates f1, f2 of the coordinate system, the user entity being further adapted for
receiving 101 a registration, REG, area represented by a geographical object descriptor;
receiving 102 an attribute, ATT, area;
   on an iterative basis
moving 103 or remaining stationary;
sensing 107 a possible new different cell from a previous cell and learning the cell coordinates X, Y of the new different cell;
sensing 109 an ATT area change;
determining 111 whether at least one of
   the cell coordinates X, Y are outside the registration area defined by the geographical object descriptor, and
   an attribute area change has occurred;
   if so, performing 113 at least a registration area update with the network involving receiving a new geographical object descriptor associated with an updated registration area;
   otherwise, performing the steps 103, 107, 109 noted under said iterative basis.

In one embodiment the user entity comprises a processor PCU_UE and a memory MEM_UE.

There is also provided a network node entity such as Mobility Management Function, MMF, node in a network comprising a plurality of cells in a cell plan for which a coordinate system is defined, wherein each cell is associated with a geographical location X, Y denoted cell coordinates in the coordinate system; the network providing radio access and communicating with the user entity,

wherein an attribute area 502 associated with at least one attribute of the network, the attribute area being defined for a first plurality of cells, a registration area 501 serving for defining a second plurality of cells of a paging area, the registration area being defined independently from the attribute area 502, the registration area being defined by a geographical object descriptor comprising at least a set of geographical coordinates f1, f2 of the coordinate system, the network node entity being adapted for
performing 123 a registration area update for a UE;
receiving 125 at least the cell coordinates X, Y of a newly sensed cell;
calculating 127 an updated registration area for the UE defined by a new geographic object descriptor based on at least the cell coordinates of the newly sensed cell;
issuing 129 the updated registration area to the UE.

The network node entity may comprise a processor PCU_M and a memory (PCU_M.

Although the solutions described above may be implemented in any appropriate type of system using any suitable components, particular embodiments of the described solutions may be implemented in a wireless network such as the example wireless communication network illustrated in FIG. 15. In the example embodiment of FIG. 15, the wireless communication network provides communication and other types of services to one or more wireless devices. In the illustrated embodiment, the wireless communication network includes one or more instances of network nodes that facilitate the wireless devices' access to and/or use of the services provided by the wireless communication network. The wireless communication network may further include any additional elements suitable to support communication between wireless devices or between a wireless device and another communication device, such as a landline telephone.

Network 220 may comprise one or more IP networks, public switched telephone networks (PSTNs), packet data networks, optical networks, wide area networks (WANs), local area networks (LANs), wireless local area networks (WLANs), wired networks, wireless networks, metropolitan area networks, and other networks to enable communication between devices.

The wireless communication network may represent any type of communication, telecommunication, data, cellular, and/or radio network or other type of system. In particular embodiments, the wireless communication network may be configured to operate according to specific standards or other types of predefined rules or procedures. Thus, particular embodiments of the wire-less communication network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Ac-cess (WiMax), Bluetooth, and/or Zig Bee standards.

FIG. 15 illustrates a wireless network comprising a more detailed view of network node 200 and wireless device (WD) 210, in accordance with a particular embodiment. For simplicity, FIG. 15 only depicts network 220, network nodes 200 and 200a, and WD 210. Network node 200 comprises processor 202, storage 203, interface 201, and antenna 201a. Similarly, WD 210 comprises processor 212, storage 213, interface 211 and antenna 211a. These components may work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components that may facilitate or participate in the communication of data and/or signals whether via wired or wireless connections.

As used herein, “network node” refers to equipment capable, configured, arranged and/or operable to communicate directly or indirectly with a wireless device and/or with other equipment in the wireless communication network that enable and/or provide wireless access to the wireless device. Examples of network nodes include, but are not limited to, access points (APs), in particular radio access points. A network node may represent base stations (BSs), such as radio base stations. Particular examples of radio base stations include Node Bs, and evolved NodeBs (eNBs). Base stations may be categorized based on the amount of coverage they provide (or, stated differently, their transmit power level) and may then also be referred to as femto base stations, pico base stations, micro base stations, or macro base stations. “Network node” also includes one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base stations may also be referred to as nodes in a distributed antenna system (DAS).

As a particular non-limiting example, a base station may be a relay node or a relay donor node controlling a relay. Yet further examples of network nodes include multi-standard radio (MSR) radio equipment such as MSR BSs, network controllers such as radio network controllers (RNCs) or base station controllers (BSCs), base transceiver stations (BTSs), transmission points, transmission nodes, Multi-cell/multicast Coordination Entities (MCEs), core network nodes (e.g., MSCs, MMEs), O&M nodes, OSS nodes, SON nodes, positioning nodes (e.g., E-SMLCs), and/or MDTs. More generally, however, network nodes may represent any suitable device (or group of devices) capable, configured, arranged, and/or operable to enable and/or provide a wireless device access to the wireless communication network or to provide some service to a wireless device that has accessed the wireless communication network.

As used herein, the term “radio node” is used generically to refer both to wireless devices and network nodes, as each is respectively described above.

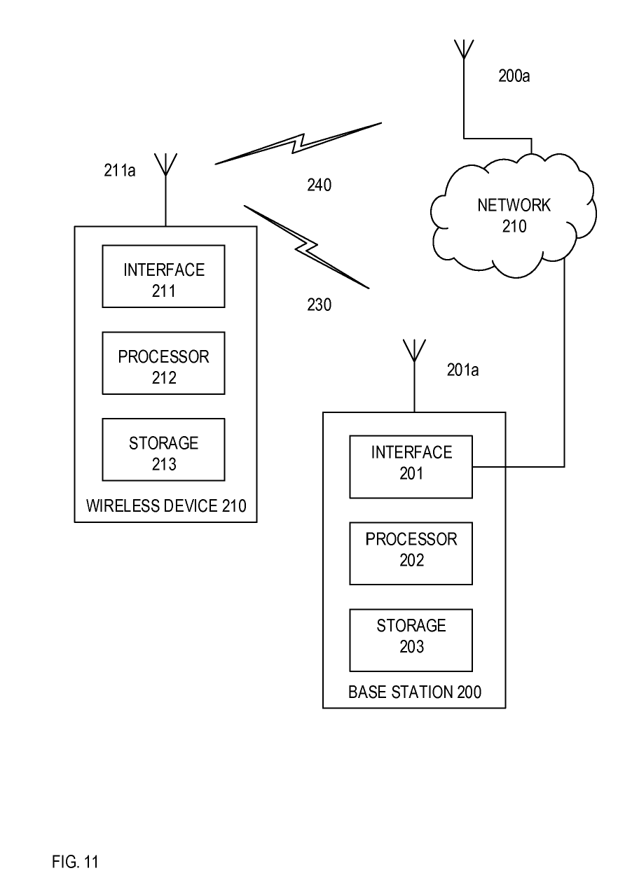

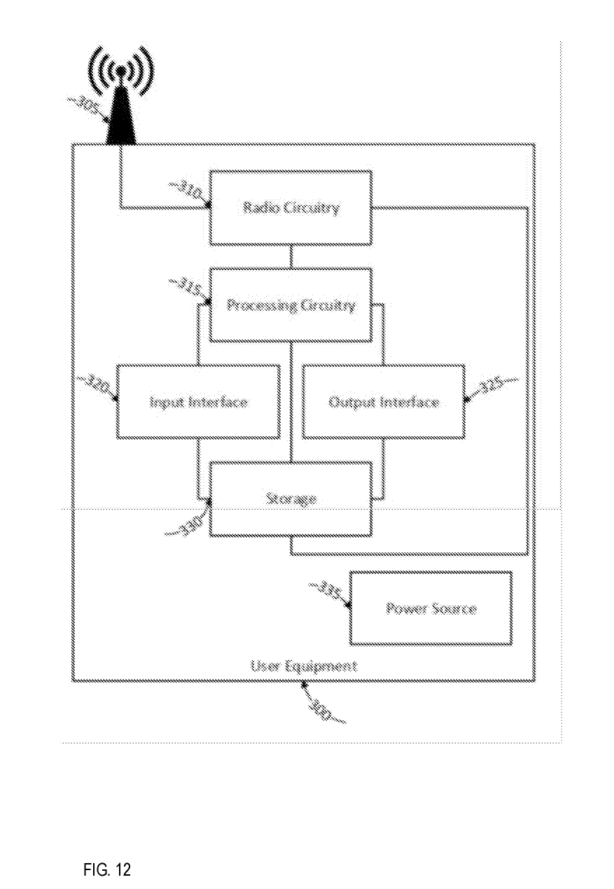

In FIG. 11, network node 200 comprises processor 202, storage 203, interface 201, and antenna 201a. These components are depicted as single boxes located within a single larger box. In practice however, a network node may comprise multiple different physical components that make up a single illustrated component (e.g., interface 201 may comprise terminals for coupling wires for a wired connection and a radio transceiver for a wireless connection). As another example, network node 200 may be a virtual network node in which multiple different physically separate components interact to provide the functionality of network node 200 (e.g., processor 202 may comprise three separate processors located in three separate enclosures, where each processor is responsible for a different function for a particular instance of network node 200). Similarly, network node 200 may be composed of multiple physically separate components (e.g., a NodeB component and a RNC component, a BTS component and a BSC component, etc.), which may each have their own respective processor, storage, and interface components. In certain scenarios in which network node 200 comprises multiple separate components (e.g., BTS and BSC components), one or more of the separate components may be shared among several network nodes. For example, a single RNC may control multiple NodeB's. In such a scenario, each unique NodeB and BSC pair, may be a separate network node. In some embodiments, network node 200 may be configured to support multiple radio access technologies (RATs). In such embodiments, some components may be duplicated (e.g., separate storage 203 for the different RATs) and some components may be reused (e.g., the same antenna 201 a may be shared by the RATs).

Processor 202 may be a combination of one or more of a microprocessor, controller, micro-controller, central processing unit, digital signal processor, application specific integrated circuit, field programmable gate array, or any other suitable computing device, resource, or combination of hardware, software and/or encoded logic operable to provide, either alone or in conjunction with other network node 200 components, such as storage 203, network node 200 functionality. For example, processor 202 may execute instructions stored in storage 203. Such functionality may include providing various wireless features discussed herein to a wireless device, such as WD 210, including any of the features or benefits disclosed herein.

Storage 203 may comprise any form of volatile or non-volatile computer readable memory including, without limitation, persistent storage, solid state memory, remotely mounted memory, magnetic media, optical media, random access memory (RAM), read-only memory (ROM), removable media, or any other suitable local or remote memory component. Storage 203 may store any suitable instructions, data or information, including software and encoded logic, utilized by network node 200. Storage 203 may be used to store any calculations made by processor 202 and/or any data received via interface 201.

Network node 200 also comprises interface 201 which may be used in the wired or wireless communication of signalling and/or data between network node 200, network 220, and/or WD 210. For example, interface 201 may perform any formatting, coding, or translating that may be needed to allow network node 200 to send and receive data from network 220 over a wired connection. Interface 201 may also include a radio transmitter and/or receiver that may be coupled to or a part of antenna 201a. The radio may receive digital data that is to be sent out to other network nodes or WDs via a wireless connection. The radio may convert the digital data into a radio signal having the appropriate channel and bandwidth parameters. The radio signal may then be transmitted via antenna 201a to the appropriate recipient (e.g., WD 210).

Antenna 201a may be any type of antenna capable of transmitting and receiving data and/or signals wirelessly. In some embodiments, antenna 201a may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line.

As used herein, “wireless device” (WD) refers to a device capable, configured, arranged and/or operable to communicate wirelessly with network nodes and/or another wireless device. Communicating wirelessly may involve transmitting and/or receiving wireless signals using electromagnetic signals, radio waves, infrared signals, and/or other types of signals suitable for conveying information through air. In particular embodiments, wireless devices may be configured to transmit and/or receive information without direct human interaction. For instance, a wireless device may be designed to transmit information to a network on a predetermined schedule, when triggered by an internal or external event, or in response to requests from the network. Generally, a wireless device may represent any device capable of, configured for, arranged for, and/or operable for wireless communication, for example radio communication devices. Examples of wireless devices include, but are not limited to, user equipment (UE) such as smart phones. Further examples include wireless cameras, wireless-enabled tablet computers, laptop-embedded equipment (LEE), laptop-mounted equipment (LME), USB dongles, and/or wireless customer-premises equipment (CPE).

As one specific example, a wireless device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. Instead, a UE may represent a device that is intended for sale to, or operation by, a human user but that may not initially be associated with a specific human user.

The wireless device may support device-to-device (D2D) communication, for example by implementing a 3GPP standard for side-link communication, and may in this case be referred to as a D2D communication device.

As yet another specific example, in an Internet of Things (IoT) scenario, a wireless device may represent a machine or other device that performs monitoring and/or measurements, and transmits the results of such monitoring and/or measurements to another wireless device and/or a network node. The wireless device may in this case be a machine-to-machine (M2M) device, which may in a 3GPP context be referred to as a machine-type communication (MTC) device. As one particular example, the wireless device may be a UE implementing the 3GPP narrow band internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a wireless device may represent a vehicle or other equipment that is capable of monitoring and/or reporting on its operational status or other functions associated with its operation.

A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As depicted in FIG. 11, WD 210 may be any type of wireless endpoint, mobile station, mobile phone, wireless local loop phone, smartphone, user equipment, desktop computer, PDA, cell phone, tablet, laptop, VoIP phone or handset, which is able to wirelessly send and receive data and/or signals to and from a network node, such as network node 200 and/or other WDs. WD 210 comprises processor 212, storage 213, interface 211, and antenna 211a. Like network node 200, the components of WD 210 are depicted as single boxes located within a single larger box, however in practice a wireless device may comprises multiple different physical components that make up a single illustrated component (e.g., storage 213 may comprise multiple discrete microchips, each microchip representing a portion of the total storage capacity). Processor 212 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in combination with other WD 210 components, such as storage 213, WD 210 functionality. Such functionality may include providing various wireless features discussed herein, including any of the features or benefits disclosed herein.

Storage 213 may be any form of volatile or non-volatile memory including, without limitation, persistent storage, solid state memory, remotely mounted memory, magnetic media, optical media, random access memory (RAM), read-only memory (ROM), removable media, or any other suitable local or remote memory component. Storage 213 may store any suitable data, instructions, or information, including software and encoded logic, utilized by WD 210. Storage 213 may be used to store any calculations made by processor 212 and/or any data received via interface 211.

Interface 211 may be used in the wireless communication of signalling and/or data between WD 210 and network node 200. For example, interface 211 may perform any formatting, coding, or translating that may be needed to allow WD 210 to send and receive data from network node 200 over a wireless connection. Interface 211 may also include a radio transmitter and/or receiver that may be coupled to or a part of antenna 211a. The radio may receive digital data that is to be sent out to network node 201 via a wireless connection. The radio may convert the digital data into a radio signal having the appropriate channel and bandwidth parameters. The radio signal may then be transmitted via antenna 211a to network node 200.

Antenna 211a may be any type of antenna capable of transmitting and receiving data and/or signals wirelessly. In some embodiments, antenna 211a may comprise one or more omni-directional, sector or panel antennas operable to transmit/receive radio signals between 2 GHz and 66 GHz. For simplicity, antenna 211a may be considered a part of interface 211 to the extent that a wireless signal is being used.

As shown in FIG. 11, user equipment 300 is an example wireless device. UE 300 includes an antenna 305, radio front-end circuitry 310, processing circuitry 315, and a computer-readable storage medium 330. Antenna 305 may include one or more antennas or antenna arrays, and is configured to send and/or receive wireless signals, and is connected to radio front-end circuitry 310. In certain alternative embodiments, wireless device 300 may not include antenna 305, and antenna 305 may instead be separate from wireless device 300 and be connectable to wireless device 300 through an interface or port.

The radio front-end circuitry 310 may comprise various filters and amplifiers, is connected to antenna 305 and processing circuitry 315, and is configured to condition signals communicated be-tween antenna 305 and processing circuitry 315. In certain alternative embodiments, wireless device 300 may not include radio front-end circuitry 310, and processing circuitry 315 may in-stead be connected to antenna 305 without radio front-end circuitry 310.

Processing circuitry 315 may include one or more of radio frequency (RF) transceiver circuitry, baseband processing circuitry, and application processing circuitry. In some embodiments, the RF transceiver circuitry, baseband processing circuitry, and application processing circuitry may be on separate chipsets. In alternative embodiments, part or all of the baseband processing circuitry and application processing circuitry may be combined into one chipset, and the RF transceiver circuitry may be on a separate chipset. In still alternative embodiments, part or all of the RF transceiver circuitry and baseband processing circuitry may be on the same chipset, and the application processing circuitry may be on a separate chipset. In yet other alternative embodiments, part or all of the RF transceiver circuitry, baseband processing circuitry, and application processing circuitry may be combined in the same chipset. Processing circuitry 315 may include, for example, one or more central processing units (CPUs), one or more microprocessors, one or more application specific integrated circuits (ASICs), and/or one or more field programmable gate arrays (FPGAs).

In particular embodiments, some or all of the functionality described herein as being provided by a wireless device may be provided by the processing circuitry 315 executing instructions stored on a computer-readable storage medium 330. In alternative embodiments, some or all of the functionality may be provided by the processing circuitry 315 without executing instructions stored on a computer-readable medium, such as in a hard-wired manner. In any of those particular embodiments, whether executing instructions stored on a computer-readable storage medium or not, the processing circuitry can be said to be configured to perform the described functionality. The benefits provided by such functionality are not limited to the processing circuitry 315 alone or to other components of UE 300, but are enjoyed by the wireless device as a whole, and/or by end users and the wireless network generally.

Antenna 305, radio front-end circuitry 310, and/or processing circuitry 315 may be configured to perform any receiving operations described herein as being performed by a wireless device. Any information, data and/or signals may be received from a network node and/or another wireless device.

The processing circuitry 315 may be configured to perform any determining operations described herein as being performed by a wireless device. Determining as performed by processing circuitry 315 may include processing information obtained by the processing circuitry 315 by, for example, converting the obtained information into other information, comparing the obtained information or converted information to information stored in the wireless device, and/or performing one or more operations based on the obtained information or converted information, and as a result of said processing making a determination.

Antenna 305, radio front-end circuitry 310, and/or processing circuitry 315 may be configured to perform any transmitting operations described herein as being performed by a wireless device. Any information, data and/or signals may be transmitted to a network node and/or another wireless device.

Computer-readable storage medium 330 is generally operable to store instructions, such as a computer program, software, an application including one or more of logic, rules, code, tables, etc. and/or other instructions capable of being executed by a processor. Examples of computer-readable storage medium 330 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or any other volatile or non-volatile, non-transitory computer-readable and/or computer-executable memory devices that store information, data, and/or instructions that may be used by processing circuitry 315. In some embodiments, processing circuitry 315 and computer-readable storage medium 330 may be considered to be integrated.

Alternative embodiments of UE 300 may include additional components beyond those shown in FIG. 16 that may be responsible for providing certain aspects of the UE's functionality, including any of the functionality described herein and/or any functionality necessary to support the solution described above. As just one example, UE 300 may include input interfaces, devices and circuits, and output interfaces, devices and circuits. Input interfaces, devices, and circuits are configured to allow input of information into UE 300, and are connected to processing circuitry 315 to allow processing circuitry 315 to process the input information. For example, input interfaces, devices, and circuits may include a microphone, a proximity or other sensor, keys/buttons, a touch display, one or more cameras, a USB port, or other input elements. Output interfaces, devices, and circuits are configured to allow output of information from UE 300, and are connected to processing circuitry 315 to allow processing circuitry 315 to output information from UE 300. For example, output interfaces, devices, or circuits may include a speaker, a dis-play, vibrating circuitry, a USB port, a headphone interface, or other output elements. Using one or more input and output interfaces, devices, and circuits, UE 300 may communicate with end users and/or the wireless network, and allow them to benefit from the functionality described herein.

As another example, UE 300 may include power source 335. Power source 335 may comprise power management circuitry. Power source 335 may receive power from a power supply, which may either be comprised in, or be external to, power source 335. For example, UE 300 may comprise a power supply in the form of a battery or battery pack which is connected to, or integrated in, power source 335. Other types of power sources, such as photovoltaic devices, may also be used. As a further example, UE 300 may be connectable to an external power supply (such as an electricity outlet) via an input circuitry or interface such as an electrical cable, whereby the external power supply supplies power to power source 335. Power source 335 may be connected to radio front-end circuitry 310, processing circuitry 315, and/or computer-readable storage medium 330 and be configured to supply UE 300, including processing circuitry 315, with power for performing the functionality described herein.

UE 300 may also include multiple sets of processing circuitry 315, computer-readable storage medium 330, radio circuitry 310, and/or antenna 305 for different wireless technologies integrated into wireless device 300, such as, for example, GSM, WCDMA, LTE, NR, Wi-Fi, or Bluetooth wireless technologies. These wireless technologies may be integrated into the same or different chipsets and other components within wireless device 300.

Any steps or features described herein are merely illustrative of certain embodiments. It is not required that all embodiments incorporate all the steps or features disclosed nor that the steps be performed in the exact order depicted or described herein. Furthermore, some embodiments may include steps or features not illustrated or described herein, including steps inherent to one or more of the steps disclosed herein.

Any appropriate steps, methods, or functions may be performed through a computer program product that may, for example, be executed by the components and equipment illustrated in one or more of the figures above. For example, storage 203 may comprise computer readable means on which a computer program can be stored. The computer program may include instructions which cause processor 202 (and any operatively coupled entities and devices, such as interface 201 and storage 203) to execute methods according to embodiments described herein. The computer program and/or computer program product may thus provide means for performing any steps herein disclosed.

Any appropriate steps, methods, or functions may be performed through one or more functional modules. Each functional module may comprise software, computer programs, sub-routines, libraries, source code, or any other form of executable instructions that are executed by, for example, a processor. In some embodiments, each functional module may be implemented in hardware and/or in software. For example, one or more or all functional modules may be implemented by processors 212 and/or 202, possibly in cooperation with storage 213 and/or 203. Processors 212 and/or 202 and storage 213 and/or 203 may thus be arranged to allow processors 212 and/or 202 to fetch instructions from storage 213 and/or 203 and execute the fetched instructions to allow the respective functional module to perform any steps or functions disclosed herein.

Certain aspects of the inventive concept have mainly been described above with reference to a few embodiments. However, as is readily appreciated by a person skilled in the art, embodiments other than the ones disclosed above are equally possible and within the scope of the inventive concept. Similarly, while a number of different combinations have been discussed, all possible combinations have not been disclosed. One skilled in the art would appreciate that other combinations exist and are within the scope of the inventive concept. Moreover, as is understood by the skilled person, the herein disclosed embodiments are as such applicable also to other standards and communication systems and any feature from a particular figure disclosed in connection with other features may be applicable to any other figure and or combined with different features.

1-29. (canceled)

30. A method for a user entity (UE) in a radio access network, the radio access network comprising a plurality of cells in a cell plan for which a coordinate system is defined, wherein each cell is associated with a geographical location denoted cell coordinates in the coordinate system; wherein the network provides radio access and communicates with the UE, wherein an attribute area is associated with at least one attribute of the network, the attribute area being defined for a first plurality of cells, where a registration area defines a second plurality of cells of a paging area, the registration area being defined independently from the attribute area, the registration area being defined by a geographical object descriptor comprising at least a set of geographical coordinates of the coordinate system; the method comprising:
receiving a registration area represented by a geographical object descriptor;
receiving an attribute area;
on an iterative basis:
moving or remaining stationary;
sensing a possible new different cell from a previous cell and learning the cell coordinates of the new different cell;
sensing an attribute area change;
determining whether at least one of following is true:
the cell coordinates are outside the registration area defined by the geographical object descriptor; and
an attribute area change has occurred;
if so, performing at least a registration area update with the network involving receiving a new geographical object descriptor associated with an updated registration area;
otherwise, performing another iteration.

31. The method of claim 30, wherein the geographical object descriptor comprises a designated geometric function and at least one geometric parameter for the designated geometric function.

32. The method of claim 30, wherein the cell coordinates are cell center coordinates.

33. The method of claim 30, wherein the UE performs an attribute area update in connection with the registration area update.

34. The method of claim 30, wherein the UE performs an estimation of the speed or the velocity of the UE, and reports the speed or the velocity of the UE to the network.

35. A method for a network node entity in a network comprising a plurality of cells in a cell plan for which a coordinate system is defined, wherein each cell is associated with a geographical location denoted cell coordinates in the coordinate system; wherein the network provides radio access and communicates with a user entity (UE); wherein an attribute area is associated with at least one attribute of the network, the attribute area being defined for a first plurality of cells; wherein a registration area defines a second plurality of cells of a paging area, the registration area being defined independently from the attribute area, the registration area being defined by a geographical object descriptor comprising at least a set of geographical coordinates of the coordinate system; the method comprising:
performing a registration area update for a UE;
receiving at least the cell coordinates of a newly sensed cell;
calculating an updated registration area for the UE defined by a new geographic object descriptor based on at least the cell coordinates of the newly sensed cell; and
issuing the updated registration area to the UE.

36. The method of claim 35, wherein the geographical object descriptor comprises a set of geographical coordinates, a designated geometric function, and at least one geometric parameter for the designated geometric function that defines a geographical location and area.

37. The method of claim 35, wherein the cell coordinates are cell center coordinates.

38. The method of claim 35, further comprising performing attribute area update in connection with the registration area update.

39. The method of claim 35, further comprising receiving the speed or velocity of the UE in addition to the cell coordinates of a newly sensed cell.

40. A user entity (UE) in a radio access network, the radio access network comprising a plurality of cells in a cell plan for which a coordinate system is defined, wherein each cell is associated with a geographical location denoted cell coordinates in the coordinate system; wherein the network provides radio access and communicates with the UE, wherein an attribute area is associated with at least one attribute of the network, the attribute area being defined for a first plurality of cells; wherein a registration area defines a second plurality of cells of a paging area, the registration area being defined independently from the attribute area, the registration area being defined by a geographical object descriptor comprising at least a set of geographical coordinates of the coordinate system; the UE comprising:
processing circuitry;
memory containing instructions executable by the processing circuitry whereby the UE is operative to:
receive a registration area represented by a geographical object descriptor;
receive an attribute area;
on an iterative basis:
move or remain stationary;
sense a possible new different cell from a previous cell and learning the cell coordinates of the new different cell;
sense an attribute area change;
determine whether at least one of following is true:
the cell coordinates are outside the registration area defined by the geographical object descriptor; and
an attribute area change has occurred;
if so, perform at least a registration area update with the network involving receiving a new geographical object descriptor associated with an updated registration area;
otherwise, perform another iteration.

41. The UE of claim 40, wherein geographical object descriptor comprises a designated geometric function and at least one geometric parameter for the designated geometric function.

42. The UE of claim 40, wherein the cell coordinates are cell center coordinates.

43. The UE of claim 40, wherein the instructions are such that the UE is operative to perform an attribute area update in connection with the registration area update.

44. The UE of claim 40, wherein the instructions are such that the UE is operative to:
perform an estimation of the speed or the velocity of the UE; and
report the speed or the velocity of the UE to the network.

45. A network node entity in a network comprising a plurality of cells in a cell plan for which a coordinate system is defined, wherein each cell is associated with a geographical location denoted cell coordinates in the coordinate system; the network providing radio access and communicating with a user entity (UE); wherein an attribute area associated with at least one attribute of the network, the attribute area being defined for a first plurality of cells; wherein a registration area defines a second plurality of cells of a paging area, the registration area being defined independently from the attribute area, the registration area being defined by a geographical object descriptor comprising at least a set of geographical coordinates of the coordinate system; the network node entity comprising:
processing circuitry;
memory containing instructions executable by the processing circuitry whereby the network node entity is operative to:
perform a registration area update for a UE;
receive at least the cell coordinates of a newly sensed cell;
calculate an updated registration area for the UE defined by a new geographic object descriptor based on at least the cell coordinates of the newly sensed cell; and
issue the updated registration area to the UE.

46. The network node entity of claim 45, wherein the geographical object descriptor comprises a set of geographical coordinates, a designated geometric function, and at least one geometric parameter for the designated geometric function that defines a geographical location and area.

47. The network node entity of claim 45, wherein the cell coordinates are cell center coordinates.

48. The network node entity of claim 45, wherein the instructions are such that the network node entity is operative to perform an attribute area update in connection with the registration area update.

49. The network node entity of claim 45, wherein the instructions are such that the network node entity is operative to receiving the speed or velocity of the UE in addition to the cell coordinates of a newly sensed cell.
